(19) United States
(12) Patent Application Publication
(10) Pub. No.: US 2015/0132721 A1
(43) Pub. Date: May 14, 2015

(54) EXERCISE AND DIET PROGRAM

(71) Applicants: Alexander DOMNICH, Edmonton (CA); Halina SOLWAY, Edmonton (CA); Gary KORZAN, Kelowna (CA)

(72) Inventors: Alexander DOMNICH, Edmonton (CA); Halina SOLWAY, Edmonton (CA); Gary KORZAN, Kelowna (CA)

(73) Assignee: ALDO CONSULTING & PROJECT MANAGEMENT LTD., Edmonton (CA)

(21) Appl. No.: 14/077,488

(22) Filed: Nov. 12, 2013

(51) Int. Cl. G09B 19/00; A23L 1/29

(52) U.S. Cl. CPC G09B 19/0092; A23L 1/293
USPC 434/127

(57) ABSTRACT

A method of individualized weight management for a subject includes obtaining a biological sample from the subject; detecting the presence or absence of polymorphisms associated with at least seven genes comprising fatty acid-binding protein 2 (FABP2), peroxisome proliferator-activated receptor gamma (PPARG), beta-2-adrenergic receptor (ADRB2), beta-3-adrenergic receptor (ADRB3), angiotensin-converting enzyme (ACE), alpha-actinin-3 (ACTN3), and proton-linked monocarboxylate transporter (MCT1) in the biological sample to obtain genotype pattern data for the subject; wherein the polymorphisms are indicative of at least one nutritional trait and at least one fitness trait and preparing a nutritional and fitness program based on the subject's genotype pattern data; wherein the fitness program comprises sequences of resistance, cardio, and excess post-exercise oxygen consumption (EPOC) training routines.

### FIELD OF THE INVENTION

The present invention relates to a method of individualized weight management by detecting the presence or absence of polymorphisms associated with the genes FABP2, PPARG, ADRB2, ADRB3, ACE, ACTN3, and MCT1 to obtain genotype pattern data which are used in the preparation of a personalized nutritional and fitness program; wherein the fitness program comprises sequences of resistance, cardio, and excess post-exercise oxygen consumption training routines.

### BACKGROUND OF THE INVENTION

Controlling body weight has many implications to people's lives, including physical health, mental health, and professional and social status. Various weight control programs have been developed including, for example, Atkins, South Beach, and The Zone. Such diets are typically based upon several macronutrient philosophies, namely a balanced diet (moderate proteins, carbohydrates and fats); the reduced carbohydrate diet; the zero-carbohydrate diet or high protein, high fat diet; and the minimal or low calorie diet. However, a particular diet may not be necessarily appropriate for all individuals. Further, it is common for fitness trainers to require several months to assess successful outcomes, if any, of a training program for a particular client. Accordingly, there is a need for an improved personalized weight management program.

### SUMMARY OF THE INVENTION

The present invention relates to a method of individualized weight management for a subject comprising the steps of:

(a) obtaining a biological sample from the subject;

(b) detecting the presence or absence of polymorphisms associated with at least seven genes comprising fatty acid-binding protein 2 (FABP2), peroxisome proliferator-activated receptor gamma (PPARG), beta-2-adrenergic receptor (ADRB2), beta-3-adrenergic receptor (ADRB3), angiotensin-converting enzyme (ACE), alpha-actinin-3 (ACTN3), and proton-linked monocarboxylate transporter (MCT1) in the biological sample to obtain genotype pattern data for the subject; wherein the polymorphisms are indicative of at least one nutritional trait and at least one fitness trait; and

(c) preparing a nutritional and fitness program based on the subject's genotype pattern data; wherein the fitness program comprises sequences of resistance, cardio, and excess post-exercise oxygen consumption (EPOC) training routines.

In one embodiment, the biological sample is selected from a cell, tissue, blood, or saliva. In one embodiment, the biological sample is DNA.

In one embodiment, the step of detecting the presence or absence of the polymorphisms comprises direct DNA sequencing. In one embodiment, the polymorphisms comprise FABP2 (AA, GA, or GG), PPARG (CC, GC, or GG), ADRB2 codon 16 (GC, GA, or AA), ADRB2 codon 27 (GG, GC, or CC), ADRB3 (CC, TT, or CT), ACE (DD, II, or ID), ACTN3 (TT, CT, or CC), and MCT1 (AA, AT, or TT).

In one embodiment, the at least one nutritional trait is selected from carbohydrate metabolism, fat metabolism, fat absorption, and fat release by fat cells. In one embodiment, the at least one fitness trait is selected from endurance, power, sprint performance, lactate removal, and mobilization of fat stores.

In one embodiment, the method further comprises performing an initial assessment of the subject to gather initial data on the subject's physical parameters and weight loss goals, and inputting the initial data into a computer storing a software program. In one embodiment, the physical parameters comprise one or more of age, gender, ethnicity, weight, height, body fat percentage, body fat mass, lean body mass, body mass index, measurements of body parts when relaxed and flexed, cardiovascular condition, muscular strength and condition, and presence or absence of disease.

In one embodiment, the method further comprises correlating the subject's polymorphisms for the FABP2, PPARG, ADRB2, and ADRB3 genes, and sensitivities to fat and carbohydrate, to a diet comprising a macronutrient ratio and fiber intake.

In one embodiment, the method comprises assigning a low fat, low carbohydrate, and high protein diet providing about 20% to about 25% fat, about 25% to about 35% carbohydrate, and about 40% to about 55% protein all on a percent calories basis, and about 30 g to about 35 g of fiber daily, to a subject sensitive to fat and sensitive to carbohydrate, and exhibiting a combined genotype of:

i) FABP2 (AA), PPARG (CC), ADRB2 codon 16 (GG), ADRB2 codon 27 (GG), and ADRB3 (TT, CC or CT);

ii) FABP2 (AA), PPARG (CC), ADRB2 codon 16 (GG), ADRB2 codon 27 (GC), and ADRB3 (TT, CC or CT);

iii) FABP2 (GA), PPARG (CC), ADRB2 codon 16 (GG or GA), ADRB2 codon 27 (GG), and ADRB3 (TT, CC or CT);

iv) FABP2 (GA), PPARG (CC), ADRB2 codon 16 (GG or GA), ADRB2 codon 27 (GC), and ADRB3 (TT, CC or CT);

v) FABP2 (GG), PPARG (CC), ADRB2 codon 16 (GA or AA), ADRB2 codon 27 (GG), and ADRB3 (CC or CT); or

vi) FABP2 (GG), PPARG (CC or GC), ADRB2 codon 16 (GG or GA or AA), ADRB2 codon 27 (GC), and ADRB3 (CC or CT).

In one embodiment, the method comprises assigning a low fat, high carbohydrate, and moderate protein diet providing about 20% to about 25% fat, about 45% carbohydrate, and about 30% to about 35% protein all on a percent calories basis, and about 25 g to about 30 g of fiber daily, to a subject sensitive to fat and moderately sensitive to carbohydrate, and exhibiting a combined genotype of:

i) FABP2 (AA), PPARG (CC or GC), ADRB2 codon 16 (GG), ADRB2 codon 27 (CC), and ADRB3 (TT, CC or CT);

ii) FABP2 (GA), PPARG (CC or GC), ADRB2 codon 16 (GG or GA), ADRB2 codon 27 (CC), and ADRB3 (TT, CC or CT); or

iii) FABP2 (GG), PPARG (CC or GC), ADRB2 codon 16 (GG or GA or AA), ADRB2 codon 27 (CC), and ADRB3 (CC or CT).

In one embodiment, the method comprises assigning a high fat, low carbohydrate, and moderate protein diet providing about 30% to about 35% fat, about 25% to about 35% carbohydrate, and about 30% to about 45% protein all on a percent calories basis, and about 25 g to about 35 g of fiber daily, to a subject tolerant to fat and sensitive to carbohydrate, and exhibiting a combined genotype of:

i) FABP2 (GG), PPARG (CC), ADRB2 codon 16 (GA or AA), ADRB2 codon 27 (GG), and ADRB3 (TT);

ii) FABP2 (GG), PPARG (CC or GC), ADRB2 codon 16 (GG or GA or AA), ADRB2 codon 27 (GC), and ADRB3 (TT);

iii) FABP2 (GG), PPARG (GG or GC), ADRB2 codon 16 (GA or AA), ADRB2 codon 27 (GG), and ADRB3 (TT, CC or CT); or

iv) FABP2 (GG), PPARG (GC), ADRB2 codon 16 (GA or AA), ADRB2 codon 27 (GC), and ADRB3 (TT, CC or CT).

In one embodiment, the method comprises assigning a high fat, high carbohydrate, and low protein diet providing about 30% to about 35% fat, about 45% carbohydrate, and about 20% to about 25% protein all on a percent calories basis, and about 25 g of fiber daily, to a subject tolerant to fat and moderately sensitive to carbohydrate, and exhibiting a combined genotype of:

i) FABP2 (GG), PPARG (CC or GC), ADRB2 codon 16 (GG or GA or AA), ADRB2 codon 27 (CC), and ADRB3 (TT); or

ii) FABP2 (GG), PPARG (GG), ADRB2 codon 16 (GA or AA), ADRB2 codon 27 (CC), and ADRB3 (TT, CC or CT).

In one embodiment, the subject exhibits a combined genotype of:

i) FABP2 (AA), PPARG (CC), ADRB2 codon 16 (GG), ADRB2 codon 27 (GG), and ADRB3 (TT, CC or CT); or

ii) FABP2 (GA), PPARG (CC), ADRB2 codon 16 (GG or GA), ADRB2 codon 27 (GG), and ADRB3 (CC or CT); and

wherein the macronutrient ratio and fiber intake comprises 20% fat, 25% carbohydrate, 55% protein all on a percent of calories basis, and 35 g fiber daily.

In one embodiment, the subject exhibits a combined genotype of:

i) FABP2 (AA), PPARG (CC), ADRB2 codon 16 (GG), ADRB2 codon 27 (GG), and ADRB3 (TT, CC, or CT); or

ii) FABP2 (GA), PPARG (CC), ADRB2 codon 16 (GG or GA), ADRB2 codon 27 (GC), and ADRB3 (CC or CT); and

wherein the macronutrient ratio and fiber intake comprises 20% fat, 35% carbohydrate, 45% protein all on a percent of calories basis, and 35 g fiber daily.

In one embodiment, the subject exhibits a combined genotype of:

i) FABP2 (AA), PPARG (CC or GC), ADRB2 codon 16 (GG), ADRB2 codon 27 (CC), and ADRB3 (TT, CC, or CT); or

ii) FABP2 (GA), PPARG (CC or GC), ADRB2 codon 16 (GG or GA), ADRB2 codon 27 (CC), and ADRB3 (CC or CT); and

wherein the macronutrient ratio and fiber intake comprises 20% fat, 45% carbohydrate, 35% protein all on a percent of calories basis, and 30 g fiber daily.

In one embodiment, the subject exhibits a combined genotype of:

i) FABP2 (GA), PPARG (CC), ADRB2 codon 16 (GG or GA), ADRB2 codon 27 (GG), and ADRB3 (TT); or

ii) FABP2 (GG), PPARG (CC), ADRB2 codon 16 (GA or AA), ADRB2 codon 27 (GG), and ADRB3 (CC or CT); and

wherein the macronutrient ratio and fiber intake comprises 25% fat, 25% carbohydrate, 50% protein all on a percent of calories basis, and 35 g fiber daily.

In one embodiment, the subject exhibits a combined genotype of:

i) FABP2 (GA), PPARG (CC), ADRB2 codon 16 (GG or GA), ADRB2 codon 27 (GG), and ADRB3 (TT); or

ii) FABP2 (GG), PPARG (CC or GC), ADRB2 codon 16 (GG, GA or AA), ADRB2 codon 27 (GC), and ADRB3 (CC or CT); and

wherein the macronutrient ratio and fiber intake comprises 25% fat, 35% carbohydrate, 40% protein all on a percent of calories basis, and 30 g fiber daily.

In one embodiment, the subject exhibits a combined genotype of:

i) FABP2 (GA), PPARG (CC or GC), ADRB2 codon 16 (GG or GA), ADRB2 codon 27 (CC), and ADRB3 (TT); or

ii) FABP2 (GG), PPARG (CC or GC), ADRB2 codon 16 (GG, GA or AA), ADRB2 codon 27 (CC), and ADRB3 (CC or CT); and

wherein the macronutrient ratio and fiber intake comprises 25% fat, 45% carbohydrate, 30% protein all on a percent of calories basis, and 25 g fiber daily.

In one embodiment, the subject exhibits a combined genotype of:

i) FABP2 (GG), PPARG (CC), ADRB2 codon 16 (GA or AA), ADRB2 codon 27 (GG), and ADRB3 (TT); or

ii) FABP2 (GG), PPARG (GG or GC), ADRB2 codon 16 (GA or AA), ADRB2 codon 27 (GG), and ADRB3 (CC or CT); and

wherein the macronutrient ratio and fiber intake comprises 30% fat, 25% carbohydrate, 45% protein all on a percent of calories basis, and 35 g fiber daily.

In one embodiment, the subject exhibits a combined genotype of:

i) FABP2 (GG), PPARG (CC or GC), ADRB2 codon 16 (GG, GA or AA), ADRB2 codon 27 (GC), and ADRB3 (TT); or

ii) FABP2 (GG), PPARG (GC), ADRB2 codon 16 (GA or AA), ADRB2 codon 27 (GC), and ADRB3 (CC or CT); and

wherein the macronutrient ratio and fiber intake comprises 30% fat, 35% carbohydrate, 35% protein all on a percent of calories basis, and 30 g fiber daily.

In one embodiment, the subject exhibits a combined genotype of:

i) FABP2 (GG), PPARG (CC or GC), ADRB2 codon 16 (GG, GA or AA), ADRB2 codon 27 (CC), and ADRB3 (TT); or

ii) FABP2 (GG), PPARG (GG), ADRB2 codon 16 (GA or AA), ADRB2 codon 27 (CC), and ADRB3 (CC or CT); and

wherein the macronutrient ratio and fiber intake comprises 30% fat, 45% carbohydrate, 25% protein all on a percent of calories basis, and 25 g fiber daily.

In one embodiment, the subject exhibits a combined genotype of FABP2 (GG), PPARG (GG or GC), ADRB2 codon 16 (GA or AA), ADRB2 codon 27 (GG), and ADRB3 (TT); and wherein the macronutrient ratio and fiber intake comprises 35% fat, 25% carbohydrate, 40% protein all on a percent of calories basis, and 30 g fiber daily.

In one embodiment, the subject exhibits a combined genotype of FABP2 (GG), PPARG (GC), ADRB2 codon 16 (GA or AA), ADRB2 codon 27 (GC), and ADRB3 (TT); and wherein the macronutrient ratio and fiber intake comprises 35% fat, 35% carbohydrate, 30% protein all on a percent of calories basis, and 25 g fiber daily.

In one embodiment, the subject exhibits a combined genotype of FABP2 (GG), PPARG (GG), ADRB2 codon 16 (GA or AA), ADRB2 codon 27 (CC), and ADRB3 (TT); and wherein the macronutrient ratio and fiber intake comprises 35% fat, 45% carbohydrate, 20% protein all on a percent of calories basis, and 25 g fiber daily.

In one embodiment, the method further comprises the step of determining the subject's caloric intake goal based on the subject's macronutrient ratio, physical parameters, weight loss goals, and energy expenditure events.

In one embodiment, the method further comprises the step of generating meal and fitness plan schedules.

In one embodiment, the meal plan schedule comprises weekly grocery lists, details for meal selection and preparation, and food exchange tables.

In one embodiment, the fitness plan schedule is prescribed based on the subject's polymorphisms for the ACE, ACTN3, MCT1, ADRB2, and ADRB3 genes. In one embodiment, the fitness plan schedule comprises a workout program prescribing sequences of resistance exercises based on the subject's polymorphisms for the ACE (DD, II, or ID), ACTN3 (TT, CT, or CC) and MCT1 (AA, AT, or TT) genes; sequences of cardio exercises based on the subject's polymorphisms for the ACE (DD, II, or ID), ADBR2 codon 27 (GG, GC, or CC) and ADBR3 (CC, TT, or CT) genes; and sequences of EPOC exercises based on the subject's polymorphisms for the ACE (DD, II, or ID) and ACTN3 (TT, CT, or CC) genes.

In one embodiment, the method further comprises gathering data on the subject's physical parameters at multiple time intervals, and calculating the changes in the physical parameters between each time interval.

In one embodiment, the method further comprises the step of modifying the meal and fitness plan schedules based on input received from the subject. In one embodiment, the input comprises changes in one or more of the caloric intake, physical parameters, or energy expenditure events.

In one embodiment, the method further comprises performing a final assessment to gather final data on the subject's physical parameters, and inputting the final data into the software program to calculate the changes in the subject's physical parameters, and to compare the physical parameters at the initial and final assessments.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 shows one embodiment of a weekly grocery list.

FIG. 2 shows one embodiment of a food exchange table.

FIGS. 3A-B show one embodiment of meals for one day.

### DETAILED DESCRIPTION OF PREFERRED EMBODIMENTS

The present invention relates to a method of individualized weight management by detecting the presence or absence of polymorphisms associated with the genes FABP2, PPARG, ADRB2, ADRB3, ACE, ACTN3, and MCT1 to obtain genotype pattern data. Particular polymorphisms of these genes are associated with certain nutritional and fitness traits. Thus, in the development of one embodiment of the present invention, it was determined that specific polymorphisms may be useful in the preparation of an individualized nutritional and fitness program. The program determines the ideal balance of proteins, carbohydrates, and fats, and fiber intake, along with the appropriate amount of calories for the subject's body type and activity level based upon his/her genotype pattern data.

To facilitate understanding of the invention, the following definitions are provided.

The term “gene” refers to a hereditary unit consisting of a sequence of DNA that occupies a specific location on a chromosome and that contains the genetic instruction for a particular characteristics or trait in an organism.

The term “genotype” or “genotypic” refers to the genetic constitution of a subject, for example, the alleles present at one or more specific loci.

The term “genotyping” refers to the process that is used to determine the subject's genotype.

The term “locus” refers to a position that a given gene occupies on a chromosome of a given species.

The term “nutritional trait” refers to a trait related to nutrition including, but not limited to, carbohydrate metabolism, fat metabolism, fat absorption, and fat release by fat cells.

The term “fitness trait” refers to a trait related to fitness including, but not limited to, endurance, power, sprint performance, lactate removal, and mobilization of fat stores.

The term “polymorphism” refers to the presence in a population of two (or more) allelic variants. Such allelic variants include sequence variation in a single base, for example a single nucleotide polymorphism or “SNP” which refers to common DNA sequence variations among subjects. The DNA sequence variation is typically a single base change or point mutation resulting in genetic variation between individuals. The single base change can be an insertion or deletion of a base.

In one embodiment, the invention comprises a method of individualized weight management for a subject comprising the steps of:

(a) obtaining a biological sample from the subject;

(b) detecting the presence or absence of polymorphisms associated with at least seven genes comprising fatty acid-binding protein 2 (FABP2), peroxisome proliferator-activated receptor gamma (PPARG), beta-2-adrenergic receptor (ADRB2), beta-3-adrenergic receptor (ADRB3), angiotensin-converting enzyme (ACE), alpha-actinin-3 (ACTN3), and proton-linked monocarboxylate transporter (MCT1) in the biological sample to obtain genotype pattern data for the subject; wherein the polymorphisms are indicative of at least one nutritional trait and at least one fitness trait; and

(c) preparing a nutritional and fitness program based on the subject's genotype pattern data; wherein the fitness program comprises sequences of resistance, cardio, and excess post-exercise oxygen consumption (EPOC) training routines.

In one embodiment, the invention comprises a method of individualized weight management by obtaining a biological sample from a subject, and detecting the presence or absence of polymorphisms associated with at least the genes FABP2, PPARG, ADRB2, ADRB3, ACE, ACTN3, and MCT1 in the biological sample. In one embodiment, the biological sample is selected from a cell, tissue, blood, or saliva. Nucleic acid (i.e., DNA or RNA) may be isolated from the biological sample by standard nucleic acid isolation techniques known to those skilled in the art. In one embodiment, the biological sample is DNA. Methods for detecting the presence or absence of polymorphisms include, but are not limited to, direct sequencing of the gene, single-strand conformation polymorphism analysis, restriction fragment length polymorphism analysis, heteroduplex analysis, gel electrophoresis, ligase chain reaction, PCR detection, and other methods known to those skilled in the art. In one embodiment, the step of detecting the presence or absence of the polymorphisms comprises direct DNA sequencing.

In one embodiment, the polymorphisms comprise FABP2 (AA, GA, or GG), PPARG (CC, GC, or GG), ADRB2 codon 16 (GG, GA, or AA), ADRB2 codon 27 (GG, GC, or CC), ADRB3 (CC, TT, or CT), ACE (DD, II, or ID), ACTN3 (TT, CT, or CC), and MCT1 (AA, AT, or TT).

As used herein, the term “fatty acid-binding protein 2” or “intestinal-type fatty acid-binding protein” (abbreviated as “FABP2” or “I-FABP”) is a 15 kDa protein encoded by the FABP2 gene, and is expressed only in the enterocytes of the small intestine villus. FABP2 is responsible for the uptake, intracellular metabolism, and transport of free long-chain fatty acids and their acyl-CoA esters. In general, FABP2 influences the absorption of fat in the small intestine. FABP2 may also modulate cell growth and proliferation by virtue of its affinity for ligands such as prostaglandins, leukotrienes and fatty acids, which are known to influence cell growth activity. A polymorphism in the FABP2 gene alters the coding sequence for FABP2. The polymorphism at codon 54 (Ala54Thr) results in an alanine encoding allele and a threonine-encoding allele. Thr-54 protein has a greater affinity for long-chain fatty acids than that of Ala54 protein. Greater affinity of the Thr-54 protein for long-chain fatty acids results in greater intestinal absorption of fatty acids, plasma lipid concentrations, and fat oxidation rates which inhibit insulin action. Consequently, Thr54 allele carriers may benefit from a low-fat diet. Certain changes in a specific SNP location in DNA can result in higher absorption of fat. This happens because altered protein causes a higher rate of binding of the fatty acids that are released in the intestine from dietary fat consumption. An individual who has the A allele demonstrates higher absorption and/or processing of dietary fatty acids by the intestine. Consequently, the A allele is associated with increased abdominal fat, higher BMI and body fat, and obesity. An individual who has the wild type G allele exhibits normal or average absorption of dietary fat.

As used herein, the term “peroxisome proliferator-activated receptor gamma” (abbreviated as “PPARG” or “PPAR-γ”) is a type II nuclear hormone receptor encoded by the PPARG gene. Two isoforms of PPARG are expressed, namely PPAR-γ1 in nearly all tissues except muscle, and PPAR-γ2 in adipose tissue and the intestine. Activation by its ligand causes it to heterodimerize with the retinoid X receptor, bind specific DNA elements and induce a transcriptional cascade which leads to adipocyte differentiation and increased sensitivity to insulin. PPARG regulates fatty acid storage and glucose metabolism. The genes activated by PPARG stimulate lipid uptake and adipogenesis by fat cells. PPARG has thus been implicated in the pathology of obesity, diabetes, atherosclerosis, and cancer. A proline to alanine substitution at codon 12 (Pro12Ala) in the PPAR-γ2 gene is associated with a decreased risk of type 2 diabetes. The proline allele confers a 25% increased risk under a recessive model. Carriers of the proline allele should monitor the quality of fat intake by increasing mono-unsaturated fatty acids in the diet and decreasing saturated fatty acids and polyunsaturated fatty acids.

While some SNPs in the PPARG gene have thus been found to result in different forms of the protein and have been associated with individuals developing type 2 diabetes, there is a variation that is involved in fat sensitivity and glucose and insulin tolerance. The G allele is associated with a decreased ability of the protein to bind to its target genes, which results in a reduced ability to regulate their expression. The amount of fat in the diet has a larger influence on individuals with the C/C genotype, and they have a direct association between the amount of fat in the diet and a higher BMI compared to the G carriers. Individuals that are C carriers (have C/C or C/G) are more sensitive to fat intake. The C allele causes an individual to be at higher risk, and individuals with C/C genotype are more sensitive to the amount of fat in their diet, more resistant to weight loss, and have a higher risk of developing type 2 diabetes.

As used herein, the term “beta-2-adrenergic receptor” (abbreviated as “ADRB2”) is a beta-adrenergic receptor encoded by the ADRB2 gene and expressed in fat cells. ADRB2 plays a key role in the breakdown of fat from the fat cells for energy in response to catecholamines, and lipolysis during exercise. Different polymorphic forms, point mutations, and/or downregulation of the ADRB2 gene are associated with obesity and type 2 diabetes. A glutamine to glutamic acid substitution at codon 27 (Gln27Glu) in the ADRB2 gene is associated with increased body mass index and fat mass. Carriers of the glutamic acid allele are less able to mobilize fat stores for energy and have a greater risk of obesity and elevated insulin levels when carbohydrate intake is greater than 49% E. An individual who has the G/G genotype can have up to 20 kg (40 lb) of excess weight and up to 50% increase in the size of fat cells compared to individuals with C/G or C/C genotypes. Decreasing intake of carbohydrate reduces insulin levels and may be beneficial in weight management for these carriers. Individuals who exercise regularly are not affected by this genetic variation. For individuals who would like to start exercising for weight loss purposes, aerobic activity is recommended as the most effective way to decrease body fat in addition to strength training to keep up the healthy muscle mass. Individuals who have G allele at codon 16 (i.e., G/G or G/A) and G/G allele at codon 27 respond more favorably to exercise, and have greater stroke volume, cardiac output and increased vasodilation, and an improved ability to clear fluid from lungs resulting in the ability to perform longer and more intense workout routines.

As used herein, the term “beta-3-adrenergic receptor” (abbreviated as “ADRB3”) is a beta-adrenergic receptor encoded by the ADRB3 gene and expressed in adipose tissue. ADRB3 is involved in the regulation of lipolysis in adipose tissue, and thermogenesis in skeletal muscle. ADRB3 induces fat breakdown in response to physical activity. Variation in this gene results in better response to aerobic exercise. However, a tryptamine to arginine substitution at codon 64 (C/T; Arg64Trp) in the ADRB3 gene is associated with increased body mass index, an enhanced capacity to gain weight, and resistance to insulin.

As used herein, the term “angiotensin-converting enzyme” (abbreviated as “ACE”) is an enzyme encoded by either of two variants of the ACE gene and expressed in skeletal muscle. ACE converts angiotensin I to angiotensin II to constrict the blood vessels, thereby raising the blood pressure. The insertion/deletion (I/D) polymorphism leading to the presence (I allele) or absence (D allele) of a 287 base pair sequence in intron 16 of the ACE gene is associated with athletic performance. The I allele (two insertions) is more frequent among elite endurance athletes and results in lower levels of angiotensin II. The D allele (two deletions) is more frequent among athletes engaged in more short distance, power-orientated sports and results in higher levels of angiotensin II. This is due to increase in creatine kinase activity in individuals with one or two copies of insertion. The genotype with two deletions is protective against muscle injury due to over exercising.

As used herein, the term “alpha-actinin-3” (abbreviated as “ACTN3”) is an actin-binding protein encoded by the ACTN3 gene and is important for muscle function. Muscle tissue consists of two types of muscle cells, namely slow twitch and fast twitch. Slow twitch cells are important for endurance type of activities due to larger number of mitochondria and myoglobin which help to utilize oxygen more efficiently to generate energy and prevent lactate build up, thereby allowing an individual to exercise for long time periods before experiencing fatigue. The fast twitch (fast glycolytic and fast oxidative glycolytic) muscle fibers are capable of producing forceful, fast, powerful contractions which are beneficial for the sprint or power performance. Such short-burst capability is required for activities such as, for example, sprinting, jumping, and plyometrics. ACTN3 is associated with the fast twitch muscles. An individual who produces an active form of the protein has the non-mutant version of the ACTN3 gene (C/C polymorphism) and has a natural predisposition for sprint-power events such as circuit training. The presence of a mutant version (R577X) or T/T variation in both copies of the ACTN3 gene prevents the synthesis of the protein and is associated with a natural predisposition for endurance events. The presence of a mutant version (R577X) in one of the two copies of the ACTN3 gene (a C/T combination) is associated with a natural predisposition for both endurance and sprint-power events.

As used therein, the term “proton-linked monocarboxylate transporter” (abbreviated as “MCT1”) is a protein encoded by the MCT1 gene and expressed in heart and muscle. MCT1 is responsible for lactate uptake from the circulation and lactate extrusion out of muscle. Lactate is the result of glucose utilization under anaerobic conditions, and is produced by muscle cells during exercise and is transported out of the cells into the bloodstream which brings it to liver for oxidation and further metabolism. During intense exercise, lactate levels rise due to inadequate levels of oxygen, resulting in a lower blood pH. A reduced rate of the transport of lactate out of the muscles can cause either fatigue or cramping of the muscles or both, resulting in lowered performance. Exercise training can increase the expression of MCT1, although the extent of this up-regulation may be related to the intensity of training. An individual who has a T/T genotype transports lactate out of the cells slowly, which may result in muscle injury during exercise. Since as much as 40-50% reduction in lactate transport has been observed, the number of repetitions and the intensity of the exercises for such an individual would have to be monitored and gradually build up to the desired level of physical activity. In contrast, an individual who has a A/A genotype (A1470T) has a 40-50% faster rate of lactate transport and can start working out with higher repetitions and intensity of the physical activity.

The subject is provided with a kit comprising one or more of a camera, body weigh scale, body fat measurement device (e.g., body composition machine, skin fold calipers, bio-impedance device), a standard measuring tape, food scale, storage containers, and measuring cups.

A computer storing a weight management software program is used in the present invention. The computer includes input control devices such as a keyboard and mouse for operating the weight management software program. A display coupled to the computer displays the information provided by the weight management software program. It should be understood that desktop computing systems, laptops, interactive televisions, terminals, handheld electronic devices (for example, mobile wireless devices and personal digital assistants) may be utilized.

An initial assessment of the subject is performed to document a starting point by gathering initial data on the subject's physical parameters and weight loss goals, and inputting the initial data into a computer storing a weight management software program. The physical parameters include, but are not limited to, age, weight, height, body fat percentage, body fat mass, lean body mass, body mass index, measurements of the body parts when relaxed and flexed (i.e., neck, shoulders, biceps, chest, waist, hip, thigh, calf). Photographs of the subject's body may be taken to provide a visual record of initial and final results. The subject may also fill out a questionnaire form to set out his personal, medical, aesthetic, or weight loss goals. The same data are gathered at subsequent, multiple time intervals (such as, for example, at weeks 4, 8, 12, 16, etc. until the final week) in order to calculate the changes in the physical parameters between each time interval, thereby providing feedback to the subject on the weight management progress or results. A final assessment is performed to gather final data on the subject's physical parameters, and input the final data into the software program to calculate the changes in the subject's physical parameters, and to compare the physical parameters at the initial and final assessments.

In one embodiment, the subject's genotype pattern data are based on the presence or absence of polymorphisms associated with at least the genes FABP2, PPARG, ADRB2, ADRB3, ACE, ACTN3, and MCT1. In one embodiment, the polymorphisms comprise FABP2 (AA, GA, or GG), PPARG (CC, GC, or GG), ADRB2 codon 16 (GG, GA, or AA), ADRB2 codon 27 (GG, GC, or CC), ADRB3 (CC, TT, or CT), ACE (DD, II, or ID), ACTN3 (TT, CT, or CC), and MCT1 (AA, AT, or TT). As summarized in Table 1, an individual will have one of the three variations indicated for each of the FABP2, PPARG, ADRB2, ADRB3, ACE, ACTN3, and MCT1 genes.

TABLE 1

| | Gene | | | | | | | |
|---|---|---|---|---|---|---|---|---|
| | | | ADBR2 | ADBR2 | | | | |
| | FABP2 | PPRAG | codon 16 | codon 27 | ADBR3 | ACTN3 | MCT1 | ACE |
| Variation | AA | CC | GG | GG | CC | TT | AA | DD |
| | GA | GC | GA | GC | TT | CT | AT | II |
| | GG | GG | AA | CC | CT | CC | TT | ID |

The subject's genotype pattern data are inputted into the weight management software program. Based on the subject's genotype pattern data, the weight management software program calculates an appropriate macronutrient ratio for the subject. As used herein, the term “macronutrient ratio” means the recommended proportions (expressed on a percent of calories basis) of carbohydrates, proteins, and fats which the subject should consume within a meal as a function of his/her genotype pattern data. Daily fiber provides vital benefits such as lowering cholesterol, eliminating waste and toxins, and improving the digestion and absorption of carbohydrates, proteins, fats, vitamins, and minerals. The subject's polymorphisms for the FABP2, PPARG, ADRB2, and ADRB3 genes, and sensitivities to fat and carbohydrate, are correlated to a diet comprising a macronutrient ratio and fiber intake. Table 2 summarizes the combinations of the gene variations which may form a subject's genotype pattern, and appropriate diet types (designated as “diet #1-12”) for each combined genotype. Table 3 summarizes each of the diet types 1-12 comprising appropriate macronutrient ratio and fiber intake for the subject. In one embodiment, the weight management software program assigns the subject a specific diet type by calculating an appropriate macronutrient ratio and fiber intake for the subject in accordance with Tables 2 and 3.

TABLE 2

| | | ADBR2 | ADBR2 | If ADRB3 is TT: | | If ADRB3 is CC or CT: | |
|---|---|---|---|---|---|---|---|
| FABP2 | PPRAG | codon 16 | codon 27 | ADRB3 | Diet# | ADRB3 | Diet# |
| AA | CC | GG | GG | TT | 1 | CC or CT | 1 |
| AA | CC | GG | GC | TT | 2 | CC or CT | 2 |
| AA | CC or GC | GG | CC | TT | 3 | CC or CT | 3 |
| GA | CC | GG or GA | GG | TT | 4 | CC or CT | 1 |
| GA | CC | GG or GA | GC | TT | 5 | CC or CT | 2 |
| GA | CC or GC | GG or GA | CC | TT | 6 | CC or CT | 3 |
| GG | CC | GA or AA | GG | TT | 7 | CC or CT | 4 |
| GG | CC or GC | GG or GA or AA | GC | TT | 8 | CC or CT | 5 |
| GG | CC or GC | GG or GA or AA | CC | TT | 9 | CC or CT | 6 |
| GG | GG or GC | GA or AA | GG | TT | 10 | CC or CT | 7 |
| GG | GC | GA or AA | GC | TT | 11 | CC or CT | 8 |
| GG | GG | GA or AA | CC | TT | 12 | CC or CT | 9 |

TABLE 3

| | Diet | Fat | Carbohydrate | Protein | Fiber |
|---|---|---|---|---|---|
| | # | (%) | (%) | (%) | (g) |
| Very Sensitive to Fat/Very Sensitive to Carbohydrate | 1 | 20 | 25 | 55 | 35 |
| Very Sensitive to Fat/Sensitive to Carbohydrate | 2 | 20 | 35 | 45 | 35 |
| Very Sensitive to Fat/Moderate to Carbohydrate | 3 | 20 | 45 | 35 | 30 |
| Sensitive to Fat/Very Sensitive to Carbohydrate | 4 | 25 | 25 | 50 | 35 |
| Sensitive to Fat/Sensitive to Carbohydrate | 5 | 25 | 35 | 40 | 30 |
| Sensitive to Fat/Moderate to Carbohydrate | 6 | 25 | 45 | 30 | 25 |
| Moderate to Fat/Very Sensitive to Carbohydrate | 7 | 30 | 25 | 45 | 35 |
| Moderate to Fat/Sensitive to Carbohydrate | 8 | 30 | 35 | 35 | 30 |
| Moderate to Fat/Moderate to Carbohydrate | 9 | 30 | 45 | 25 | 25 |
| Higher Tolerance to Fat/Very Sensitive to Carbohydrate | 10 | 35 | 25 | 40 | 30 |
| Higher Tolerance to Fat/Sensitive to Carbohydrate | 11 | 35 | 35 | 30 | 25 |
| Higher Tolerance to Fat/Moderate to Carbohydrate | 12 | 35 | 45 | 20 | 25 |

The subject's caloric intake goal is determined based on the subject's macronutrient ratio, physical parameters, and energy expenditure events. As used herein, “energy expenditure events” are any physical activities or bodily movements produced by skeletal muscles which require energy expenditure including, but not limited to, walking, jogging, running, cycling, swimming, dancing, participation in any sport, aerobic or anaerobic exercises. As used herein “aerobic exercise” refers to low or moderate intensity exercise employed during long endurance activities, such as long distance running, swimming, and cycling. As used herein, “anaerobic exercise” refers to high-intensity exercise used in short duration activities, such as sprinting, and high-intensity resistance training.

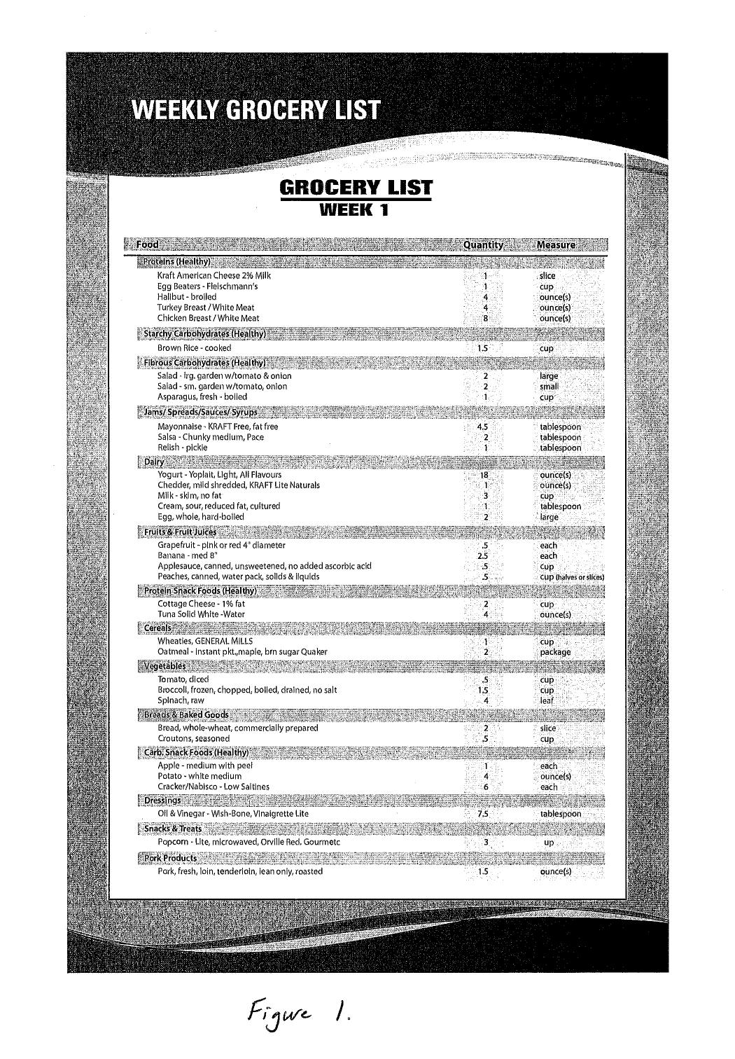

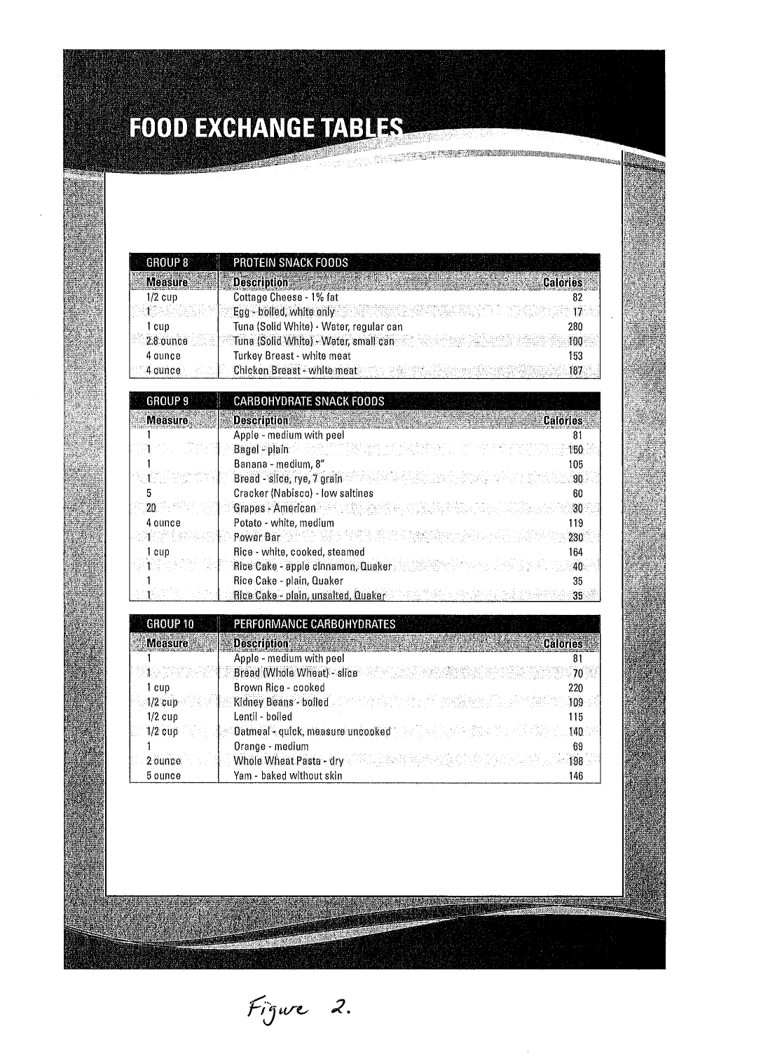

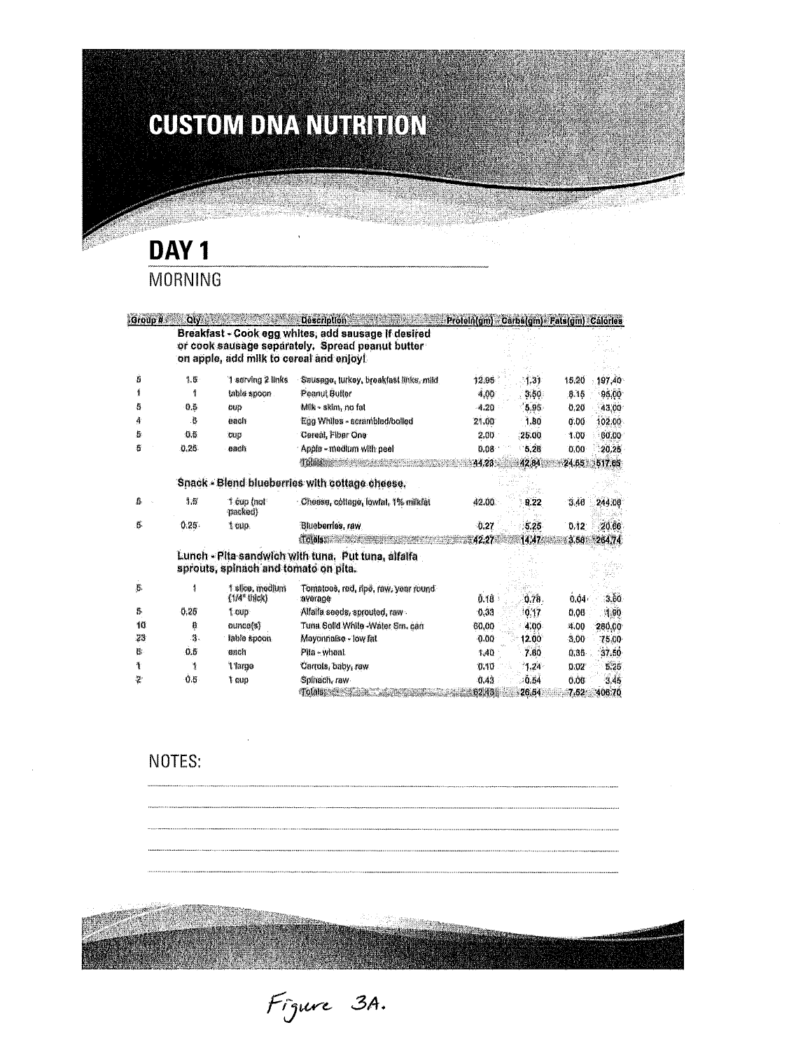

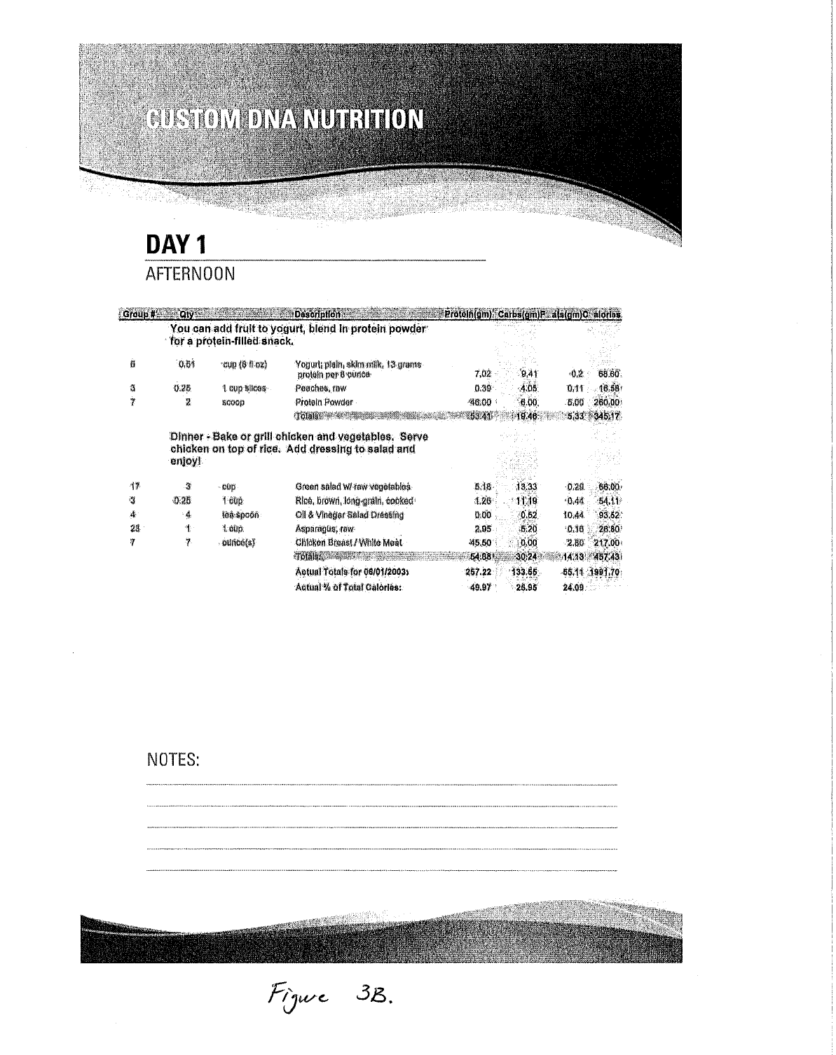

Based on the above profile for the subject, the weight management software program generates suitable individualized meal and fitness plan schedules for the subject. In one embodiment, the meal plan schedule comprises weekly grocery lists, details for meal selection and preparation, and food exchange tables. Each meal is based on the macronutrient ratio as determined by the subject's sensitivity to fats and carbohydrates, and comprises an appropriate percentage of carbohydrates, proteins, and fats (all on a percent of calories basis) as determined by the subject's genotype pattern data and a suitable amount of fiber intake daily (Tables 2 and 3). FIG. 1 shows an exemplary grocery list for week 1 of the program. FIG. 2 shows an exemplary food exchange table which assists the subject in replacing ingredients in his custom meal schedule with other ingredients having similar nutritional value. FIGS. 3A-B show examples of meals for a subject on day 1 of the meal schedule.

The fitness plan schedule comprises a workout program of exercises, sports (for example, a sprint/power sport or an endurance sport), or training regimens which are appropriately matched to the subject's genotype pattern data. In one embodiment, the fitness program comprises sequences of resistance, cardio, and excess post-exercise oxygen consumption training routines. In one embodiment, the fitness plan schedule is prescribed based on the subject's polymorphisms for the ACE, ACTN3, MCT1, ADRB2, and ADRB3 genes. In one embodiment, the fitness plan schedule comprises a workout program prescribing sequences of resistance exercises based on the subject's polymorphisms for the ACE (DD, II, or ID), ACTN3 (TT, CT, or CC) and MCT1 (AA, AT, or TT) genes; sequences of cardio exercises based on the subject's polymorphisms for the ACE (DD, II, or ID), ADBR2 codon 27 (GG, GC, or CC) and ADBR3 (CC, TT, or CT) genes; and sequences of EPOC exercises based on the subject's polymorphisms for the ACE (DD, II, or ID) and ACTN3 (TT, CT, or CC) genes.

As used herein, the term “resistance” refers to strength training which is performed to increase the strength and mass of muscles, bone strength and metabolism. Resistance exercises include, but are not limited to, weight machines, free weights (for example, bicep curls, tricep dips), and calisthenics (for example push-ups, sit-ups, chin-ups, lunges). In one embodiment, the fitness program comprises resistance training routines in accordance with the subject's polymorphisms for the ACE (DD, II, or ID), ACTN3 (TT, CT, or CC) and MCT1 (AA, AT, or TT) genes, as set out in Table 4. As used herein, one repetition maximum (abbreviated as “1RM”) refers to the maximum amount of weight the subject can lift in a single repetition for a given exercise. The 1RM is calculated by the following formula:

Weight×(1+(0.033×number of repetitions)) (1)

TABLE 4
Resistance Training Routines

| | | | | | |
|---|---|---|---|---|---|
| Training | ACE | DD | ACTN3 | TT | Beginner: 30 min < 70% 1RM. |
| duration and | | | | | Intermediate: 30-45 min/60-80% 1RM |
| intensity of | | | | | Advanced: 45-60 min/60-100% 1RM |
| repetitions | | | | | Repetition speed: 4 second rep - medium speed, |
| | | | | | pause between |
| | | | | CT | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 2 second rep go to 4 second rep - |
| | | | | | do first half of set explosive than slow it down |
| | | | | CC | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 1-2 sec rep - Explosive muscle |
| | | | | | contraction with normal speed retraction. |
| | | II | ACTN3 | TT | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 6 second rep - Med. Speed, Pause between. |
| | | | | CT | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 4 second rep go to 6 second rep - |
| | | | | | Do first half of set explosive then slow it down. |
| | | | | CC | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 2-4 sec rep - explosive contraction/normal speed |
| | | | | | retraction |
| | | ID | ACTN3 | TT | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 50% of sets 4 second rep and 50% |
| | | | | | of sets 6 second rep - Med. Speed, Pause between. |
| | | | | CT | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 2 second rep go to 4 second rep - |
| | | | | | Do first half of set explosive then slow it down. |
| | | | | CC | Beginner: 30 min < 70% 1RM. |
| | | | | | Intermediate: 30-45 min/60-80% 1RM |
| | | | | | Advanced: 45-60 min/60-100% 1RM |
| | | | | | Repetition speed: 50% of sets faster 1-2 sec rep and 50% |
| | | | | | of sets slower 3-4 sec rep - fast contraction/normal speed retraction. |

| | | | |
|---|---|---|---|
| Training regime | MCT1 | AA | Muscle maintenance mode |
| | | | Reps: 12-16, Weight 60-70% 1RM, |
| | | | Rest: 15-30 seconds |
| | | | Muscle volume building mode |
| | | | Reps: 8-12, Weight 70-85% 1RM, |
| | | | Rest: 30-60 seconds |
| | MCT2 | AT | Muscle maintenance mode |
| | | | Reps: 10-14, Weight 65-75% 1RM, |
| | | | Rest: 30-60 seconds |
| | | | Muscle volume building mode |
| | | | Reps: 6-10, Weight 75-90% 1RM, |
| | | | Rest: 60-120 seconds |
| | MCT3 | TT | Muscle maintenance mode |
| | | | Reps: 8-12, Weight 75-85% 1RM, |
| | | | Rest: 60-120 seconds |
| | | | Muscle volume building mode |
| | | | Reps: 4-8, Weight 85-95% 1RM, |
| | | | Rest: 120-180 seconds |

As used herein, the term “cardio” refers to any exercise which raises the heart rate. Cardio exercises include, but are not limited to, walking, running, cycling, swimming, and aerobic workouts. In one embodiment, the fitness program comprises cardio training routines in accordance with the subject's polymorphisms for the ACE (DD, II, or ID), ADBR2 codon 27 (GG, GC, or CC) and ADBR3 (CC, TT, or CT) genes, as set out in Tables 5 and 6. The exercise heart rates based on VO2 max for males and females are calculated from Tables 7 and 8. As used herein, the term “VO2 max” refers to the maximal oxygen uptake or the maximum volume of oxygen that can be utilized in one minute during maximal or exhaustive exercise, and is measured as milliliters of oxygen used in one minute per kilogram of body weight.

TABLE 5
Training frequency

| | | |
|---|---|---|
| ADRB3 | CC | Beginner: 2-3 times per week resistance and cardio workouts |
| | | Intermediate: 3-4 times per week resistance and cardio workouts |
| | | Advanced: 4-5 times per week resistance and cardio workouts |
| | TT or CT | Beginner: 2-3 times per week of regular resistance/cardio workouts |
| | | and add 2 more days of cardio. |
| | | Intermediate: 3-4 times per week (select based on goals and time) of |
| | | regular resistance/cardio workouts and add 2 more days of cardio. |
| | | Advanced: 4-5 times per week of regular resistance/cardio workouts |
| | | and add 2 more days of cardio. |

TABLE 6
Cardio Training Routines

| | | | |
|---|---|---|---|
| Training regime | ACE | DD | The body responds best to harder vs. faster training to achieve |
| | | | needed heart rate/VO2 max %. Add resistance or incline to cardio |
| | | | machines. |
| | | II | Due to the body's increased ability to utilize oxygen, benefit is |
| | | | greatest from more complex movement to maximize demand for |
| | | | oxygenation. Use machines/movements that require more of the |
| | | | whole body during cardio-muscular movements. Deploy speed |
| | | | instead of resistance or incline to achieve needed HR (VO2 max |
| | | | %). |
| | | ID | Limit time spent performing high intensity so that endurance |
| | | | fibers can be exhausted. Combine intervals of resistance or incline |
| | | | with no resistance and just speed to achieve needed HR (VO2 |
| | | | max %). |
| Training duration | ADRB2 | CC | Beginner: 55-64% (VO2 max) - 15-25 min. |
| and intensity | codon 27 | | Intermediate: 65-74% (VO2 max) - 20-35 min. |
| (HR/VO2 max) | | | Advanced: 75-90% (VO2 max) - 25-45 min. |
| | | | *Add tempo to cardio |
| | | GG or GC | Beginner: 55-64% (VO2 max) - 25-35 min. |
| | | | Intermediate: 65-74% (VO2 max) - 30-45 min. |
| | | | Advanced: 75-90% (VO2 max) - 40-60 min. |

TABLE 7

| | | % VO2 max | | | | | | | | | | | | | |
|---|---|---|---|---|---|---|---|---|---|---|---|---|---|---|---|
| | | 30% | 40% | 50% | 60% | 65% | 70% | 75% | 80% | 85% | 90% | 95% | 100% | 105% | 110% |
| AGE | MHR | Exercise Heart Rate for MAN based on % VO2 max | | | | | | | | | | | | | |
| 21 | 199 | 112 | 125 | 137 | 150 | 156 | 163 | 169 | 176 | 182 | 188 | 195 | 201 | 207 | 214 |
| 22 | 198 | 111 | 124 | 137 | 149 | 156 | 162 | 168 | 175 | 181 | 187 | 194 | 200 | 206 | 213 |
| 23 | 197 | 111 | 123 | 136 | 149 | 155 | 161 | 167 | 174 | 180 | 186 | 193 | 199 | 205 | 212 |
| 24 | 196 | 110 | 123 | 135 | 148 | 154 | 160 | 167 | 173 | 179 | 185 | 192 | 198 | 204 | 211 |
| 25 | 195 | 110 | 122 | 135 | 147 | 153 | 160 | 166 | 172 | 178 | 184 | 191 | 197 | 203 | 209 |
| 26 | 194 | 109 | 121 | 134 | 146 | 152 | 159 | 165 | 171 | 177 | 184 | 190 | 196 | 202 | 208 |
| 27 | 193 | 108 | 121 | 133 | 146 | 152 | 158 | 164 | 170 | 176 | 183 | 189 | 195 | 201 | 207 |
| 28 | 192 | 108 | 120 | 132 | 145 | 151 | 157 | 163 | 169 | 175 | 182 | 188 | 194 | 200 | 206 |
| 29 | 191 | 107 | 120 | 132 | 144 | 150 | 156 | 162 | 168 | 175 | 181 | 187 | 193 | 199 | 205 |
| 30 | 190 | 107 | 119 | 131 | 143 | 149 | 155 | 162 | 168 | 174 | 180 | 186 | 192 | 198 | 204 |
| 31 | 189 | 106 | 118 | 130 | 143 | 149 | 155 | 161 | 167 | 173 | 179 | 185 | 191 | 197 | 203 |
| 32 | 188 | 106 | 118 | 130 | 142 | 148 | 154 | 160 | 166 | 172 | 178 | 184 | 190 | 196 | 202 |
| 33 | 187 | 105 | 117 | 129 | 141 | 147 | 153 | 159 | 165 | 171 | 177 | 183 | 189 | 195 | 201 |
| 34 | 186 | 105 | 116 | 128 | 140 | 146 | 152 | 158 | 164 | 170 | 176 | 182 | 188 | 194 | 200 |
| 35 | 185 | 104 | 116 | 128 | 139 | 145 | 151 | 157 | 163 | 169 | 175 | 181 | 187 | 193 | 199 |
| 36 | 184 | 103 | 115 | 127 | 139 | 145 | 151 | 156 | 162 | 168 | 174 | 180 | 186 | 192 | 198 |
| 37 | 183 | 103 | 115 | 126 | 138 | 144 | 150 | 156 | 161 | 167 | 173 | 179 | 185 | 191 | 197 |
| 38 | 182 | 102 | 114 | 126 | 137 | 143 | 149 | 155 | 161 | 166 | 172 | 178 | 184 | 190 | 195 |
| 39 | 181 | 102 | 113 | 125 | 136 | 142 | 148 | 154 | 160 | 165 | 171 | 177 | 183 | 189 | 194 |
| 40 | 180 | 101 | 113 | 124 | 136 | 141 | 147 | 153 | 159 | 165 | 170 | 176 | 182 | 188 | 193 |
| 41 | 179 | 101 | 112 | 124 | 135 | 141 | 146 | 152 | 158 | 164 | 169 | 175 | 181 | 187 | 192 |
| 42 | 178 | 100 | 111 | 123 | 134 | 140 | 146 | 151 | 157 | 163 | 168 | 174 | 180 | 185 | 191 |
| 43 | 177 | 99 | 111 | 122 | 133 | 139 | 145 | 150 | 156 | 162 | 167 | 173 | 179 | 184 | 190 |
| 44 | 176 | 99 | 110 | 121 | 133 | 138 | 144 | 150 | 155 | 161 | 166 | 172 | 178 | 183 | 189 |
| 45 | 175 | 98 | 110 | 121 | 132 | 138 | 143 | 149 | 154 | 160 | 166 | 171 | 177 | 182 | 188 |
| 46 | 174 | 98 | 109 | 120 | 131 | 137 | 142 | 148 | 153 | 159 | 165 | 170 | 176 | 181 | 187 |
| 47 | 173 | 97 | 108 | 119 | 130 | 136 | 142 | 147 | 153 | 158 | 164 | 169 | 175 | 180 | 186 |
| 48 | 172 | 97 | 108 | 119 | 130 | 135 | 141 | 146 | 152 | 157 | 163 | 168 | 174 | 179 | 185 |
| 49 | 171 | 96 | 107 | 118 | 129 | 134 | 140 | 145 | 151 | 156 | 162 | 167 | 173 | 178 | 184 |
| 50 | 170 | 96 | 106 | 117 | 128 | 134 | 139 | 145 | 150 | 155 | 161 | 166 | 172 | 177 | 183 |
| 51 | 169 | 95 | 106 | 117 | 127 | 133 | 138 | 144 | 149 | 154 | 160 | 165 | 171 | 176 | 182 |
| 52 | 168 | 94 | 105 | 116 | 127 | 132 | 137 | 143 | 148 | 154 | 159 | 164 | 170 | 175 | 180 |
| 53 | 167 | 94 | 105 | 115 | 126 | 131 | 137 | 142 | 147 | 153 | 158 | 163 | 169 | 174 | 179 |
| 54 | 166 | 93 | 104 | 115 | 125 | 130 | 136 | 141 | 146 | 152 | 157 | 162 | 168 | 173 | 178 |
| 55 | 165 | 93 | 103 | 114 | 124 | 130 | 135 | 140 | 146 | 151 | 156 | 161 | 167 | 172 | 177 |
| 56 | 164 | 92 | 103 | 113 | 124 | 129 | 134 | 139 | 145 | 150 | 155 | 160 | 166 | 171 | 176 |
| 57 | 163 | 92 | 102 | 112 | 123 | 128 | 133 | 139 | 144 | 149 | 154 | 159 | 165 | 170 | 175 |
| 58 | 162 | 91 | 101 | 112 | 122 | 127 | 133 | 138 | 143 | 148 | 153 | 158 | 164 | 169 | 174 |
| 59 | 161 | 90 | 101 | 111 | 121 | 127 | 132 | 137 | 142 | 147 | 152 | 157 | 163 | 168 | 173 |
| 60 | 160 | 90 | 100 | 110 | 121 | 126 | 131 | 136 | 141 | 146 | 151 | 156 | 162 | 167 | 172 |
| 61 | 159 | 89 | 100 | 110 | 120 | 125 | 130 | 135 | 140 | 145 | 150 | 156 | 161 | 166 | 171 |
| 62 | 158 | 89 | 99 | 109 | 119 | 124 | 129 | 134 | 139 | 144 | 149 | 155 | 160 | 165 | 170 |
| 63 | 157 | 88 | 98 | 108 | 118 | 123 | 128 | 133 | 138 | 143 | 149 | 154 | 159 | 164 | 169 |
| 64 | 156 | 88 | 98 | 108 | 118 | 123 | 128 | 133 | 138 | 143 | 148 | 153 | 158 | 163 | 168 |
| 65 | 155 | 87 | 97 | 107 | 117 | 122 | 127 | 132 | 137 | 142 | 147 | 152 | 157 | 162 | 166 |
| 66 | 154 | 87 | 96 | 106 | 116 | 121 | 126 | 131 | 136 | 141 | 146 | 151 | 156 | 160 | 165 |
| 67 | 153 | 86 | 96 | 106 | 115 | 120 | 125 | 130 | 135 | 140 | 145 | 150 | 155 | 159 | 164 |
| 68 | 152 | 85 | 95 | 105 | 115 | 119 | 124 | 129 | 134 | 139 | 144 | 149 | 154 | 158 | 163 |
| 69 | 151 | 85 | 95 | 104 | 114 | 119 | 124 | 128 | 133 | 138 | 143 | 148 | 153 | 157 | 162 |
| 70 | 150 | 84 | 94 | 104 | 113 | 118 | 123 | 128 | 132 | 137 | 142 | 147 | 152 | 156 | 161 |

TABLE 8

| | | % VO2 max | | | | | | | | | | | | | |
|---|---|---|---|---|---|---|---|---|---|---|---|---|---|---|---|
| | | 30% | 40% | 50% | 60% | 65% | 70% | 75% | 80% | 85% | 90% | 95% | 100% | 105% | 110% |
| AGE | MHR | Exercise Heart Rate for WOMAN based on % VO2 max | | | | | | | | | | | | | |
| 21 | 188 | 105 | 117 | 129 | 141 | 147 | 153 | 159 | 165 | 171 | 177 | 183 | 189 | 195 | 201 |
| 22 | 187 | 105 | 117 | 129 | 141 | 147 | 153 | 159 | 165 | 171 | 177 | 183 | 189 | 194 | 200 |
| 23 | 186 | 104 | 116 | 128 | 140 | 146 | 152 | 158 | 164 | 170 | 176 | 182 | 188 | 194 | 200 |
| 24 | 185 | 104 | 116 | 128 | 139 | 145 | 151 | 157 | 163 | 169 | 175 | 181 | 187 | 193 | 199 |
| 25 | 184 | 103 | 115 | 127 | 139 | 145 | 151 | 156 | 162 | 168 | 174 | 180 | 186 | 192 | 198 |
| 26 | 183 | 103 | 115 | 126 | 138 | 144 | 150 | 156 | 162 | 167 | 173 | 179 | 185 | 191 | 197 |
| 27 | 182 | 102 | 114 | 126 | 137 | 143 | 149 | 155 | 161 | 167 | 172 | 178 | 184 | 190 | 196 |
| 28 | 181 | 102 | 114 | 125 | 137 | 143 | 148 | 154 | 160 | 166 | 172 | 177 | 183 | 189 | 195 |
| 29 | 180 | 101 | 113 | 125 | 136 | 142 | 148 | 153 | 159 | 165 | 171 | 177 | 182 | 188 | 194 |
| 30 | 180 | 101 | 112 | 124 | 135 | 141 | 147 | 153 | 158 | 164 | 170 | 176 | 181 | 187 | 193 |
| 31 | 179 | 100 | 112 | 123 | 135 | 140 | 146 | 152 | 158 | 163 | 169 | 175 | 181 | 186 | 192 |
| 32 | 178 | 100 | 111 | 123 | 134 | 140 | 145 | 151 | 157 | 163 | 168 | 174 | 180 | 185 | 191 |
| 33 | 177 | 99 | 111 | 122 | 133 | 139 | 145 | 150 | 156 | 162 | 167 | 173 | 179 | 184 | 190 |
| 34 | 176 | 99 | 110 | 121 | 133 | 138 | 144 | 150 | 155 | 161 | 167 | 172 | 178 | 183 | 189 |
| 35 | 175 | 98 | 110 | 121 | 132 | 138 | 143 | 149 | 155 | 160 | 166 | 171 | 177 | 183 | 188 |
| 36 | 174 | 98 | 109 | 120 | 131 | 137 | 143 | 148 | 154 | 159 | 165 | 170 | 176 | 182 | 187 |
| 37 | 173 | 97 | 109 | 120 | 131 | 136 | 142 | 147 | 153 | 159 | 164 | 170 | 175 | 181 | 186 |
| 38 | 173 | 97 | 108 | 119 | 130 | 136 | 141 | 147 | 152 | 158 | 163 | 169 | 174 | 180 | 185 |
| 39 | 172 | 96 | 107 | 118 | 129 | 135 | 140 | 146 | 151 | 157 | 162 | 168 | 173 | 179 | 184 |
| 40 | 171 | 96 | 107 | 118 | 129 | 134 | 140 | 145 | 151 | 156 | 162 | 167 | 173 | 178 | 183 |
| 41 | 170 | 95 | 106 | 117 | 128 | 134 | 139 | 144 | 150 | 155 | 161 | 166 | 172 | 177 | 182 |
| 42 | 169 | 95 | 106 | 117 | 127 | 133 | 138 | 144 | 149 | 155 | 160 | 165 | 171 | 176 | 182 |
| 43 | 168 | 95 | 105 | 116 | 127 | 132 | 138 | 143 | 148 | 154 | 159 | 164 | 170 | 175 | 181 |
| 44 | 167 | 94 | 105 | 115 | 126 | 131 | 137 | 142 | 148 | 153 | 158 | 164 | 169 | 174 | 180 |
| 45 | 166 | 94 | 104 | 115 | 125 | 131 | 136 | 141 | 147 | 152 | 157 | 163 | 168 | 173 | 179 |
| 46 | 166 | 93 | 104 | 114 | 125 | 130 | 135 | 141 | 146 | 151 | 157 | 162 | 167 | 172 | 178 |
| 47 | 165 | 93 | 103 | 114 | 124 | 129 | 135 | 140 | 145 | 150 | 156 | 161 | 166 | 172 | 177 |
| 48 | 164 | 92 | 103 | 113 | 123 | 129 | 134 | 139 | 144 | 150 | 155 | 160 | 165 | 171 | 176 |
| 49 | 163 | 92 | 102 | 112 | 123 | 128 | 133 | 138 | 144 | 149 | 154 | 159 | 165 | 170 | 175 |
| 50 | 162 | 91 | 101 | 112 | 122 | 127 | 133 | 138 | 143 | 148 | 153 | 158 | 164 | 169 | 174 |
| 51 | 161 | 91 | 101 | 111 | 121 | 127 | 132 | 137 | 142 | 147 | 152 | 158 | 163 | 168 | 173 |
| 52 | 160 | 90 | 100 | 111 | 121 | 126 | 131 | 136 | 141 | 146 | 152 | 157 | 162 | 167 | 172 |
| 53 | 159 | 90 | 100 | 110 | 120 | 125 | 130 | 135 | 141 | 146 | 151 | 156 | 161 | 166 | 171 |
| 54 | 158 | 89 | 99 | 109 | 119 | 125 | 130 | 135 | 140 | 145 | 150 | 155 | 160 | 165 | 170 |
| 55 | 158 | 89 | 99 | 109 | 119 | 124 | 129 | 134 | 139 | 144 | 149 | 154 | 159 | 164 | 169 |
| 56 | 157 | 88 | 98 | 108 | 118 | 123 | 128 | 133 | 138 | 143 | 148 | 153 | 158 | 163 | 168 |
| 57 | 156 | 88 | 98 | 108 | 118 | 122 | 127 | 132 | 137 | 142 | 147 | 152 | 157 | 162 | 167 |
| 58 | 155 | 87 | 97 | 107 | 117 | 122 | 127 | 132 | 137 | 142 | 147 | 152 | 157 | 161 | 166 |
| 59 | 154 | 87 | 96 | 106 | 116 | 121 | 126 | 131 | 136 | 141 | 146 | 151 | 156 | 161 | 165 |
| 60 | 153 | 86 | 96 | 106 | 116 | 120 | 125 | 130 | 135 | 140 | 145 | 150 | 155 | 160 | 165 |
| 61 | 152 | 86 | 95 | 105 | 115 | 120 | 125 | 129 | 134 | 139 | 144 | 149 | 154 | 159 | 164 |
| 62 | 151 | 85 | 95 | 104 | 114 | 119 | 124 | 129 | 134 | 138 | 143 | 148 | 153 | 158 | 163 |
| 63 | 151 | 85 | 94 | 104 | 114 | 118 | 123 | 128 | 133 | 138 | 142 | 147 | 152 | 157 | 162 |
| 64 | 150 | 84 | 94 | 103 | 113 | 118 | 122 | 127 | 132 | 137 | 142 | 146 | 151 | 156 | 161 |
| 65 | 149 | 84 | 93 | 103 | 112 | 117 | 122 | 126 | 131 | 136 | 141 | 146 | 150 | 155 | 160 |
| 66 | 148 | 83 | 93 | 102 | 112 | 116 | 121 | 126 | 130 | 135 | 140 | 145 | 149 | 154 | 159 |
| 67 | 147 | 83 | 92 | 101 | 111 | 116 | 120 | 125 | 130 | 134 | 139 | 144 | 149 | 153 | 158 |
| 68 | 146 | 82 | 91 | 101 | 110 | 115 | 120 | 124 | 129 | 134 | 138 | 143 | 148 | 152 | 157 |
| 69 | 145 | 82 | 91 | 100 | 110 | 114 | 119 | 123 | 128 | 133 | 137 | 142 | 147 | 151 | 156 |
| 70 | 144 | 81 | 90 | 100 | 109 | 113 | 118 | 123 | 127 | 132 | 137 | 141 | 146 | 150 | 155 |

As used herein, the term “excess post-exercise oxygen consumption” (abbreviated as “EPOC”) refers to the exercise after-burn, or the calories expended (above resting values) after an exercise bout. EPOC represents the oxygen consumption above resting level that the body uses to return itself to its pre-exercise state. The physiological mechanisms responsible for this increased metabolism include the replenishment of oxygen stores, phosphagen resynthesis, lactate removal, and increased ventilation, blood circulation and body temperature above pre-exercise levels. The magnitude (amount of elevation in oxygen consumption) and duration (length of time the oxygen consumption is elevated) of EPOC are dependent on the intensity and duration of exercise. The EPOC effect is greatest soon after the exercise is completed and decays to a lower level over time. In one embodiment, the fitness program comprises an EPOC training routine in accordance with the subject's polymorphisms for the ACE (DD, II, or ID) and ACTN3 (TT, CT, or CC) genes, as set out in Table 9. Tables 10 and 11 set out the heart rate intensities (beats per minute) for men and women as required for the EPOC training routine.

TABLE 9
EPOC Training Routine

| | | | | | Cardio |
|---|---|---|---|---|---|
| | | | | | Calculate EPOC workout heart rate |
| | | | | Resistance | according to the age |
| ACE | DD | ACTN3 | TT | Heavy resistance training: 2-4 sets, 8-10 exercises, 3-8 | Alternate 3 min bouts (30-40% |
| | | | | reps at 80-90% 1RM. | VO2 max) of low intensity and 3 |
| | | | | Repetition speed: 4 second rep - medium speed, pause | min bouts of high intensity (80- |
| | | | | between | 90% VO2 max) exercise for a |
| | | | | | period of 20-40 minutes. |
| | | | CT | Heavy resistance training: 2-4 sets, 8-10 exercises, 3-8 | Interval training of 15-20 |
| | | | | reps at 80-90% 1RM. | supramaximal (105-110% |
| | | | | Repetition speed: 2 second rep go to 4 second rep - do | VO2 max) exercise bouts for a |
| | | | | first half of set explosive then slow it down | period of 1 minute, with 2-5 |
| | | | CC | Heavy resistance training: 2-4 sets, 8-10 exercises, 3-8 | minute rest (slow/rest tempo) |
| | | | | reps at 80-90% 1RM. | |
| | | | | Repetition speed: 1-2 sec rep - Explosive muscle | |
| | | | | contraction with normal speed retraction. | |
| | II | ACTN3 | TT | Circuit Resistance training: 2-3 circuit sets, 6-10 | Long slow distance training by |
| | | | | exercises, 10-12 reps at 50% 1RM. | means of continuous aerobic |
| | | | | Repetition speed: 6 second rep - Med. Speed, Pause | exercise at a moderate |
| | | | | between. | intensity (60-70% VO2 max) for a |
| | | | | | period of 20-40 minutes. |
| | | | CT | Circuit Resistance training: 2-3 circuit sets, 6-10 | Split training of 2 to 4 high- |
| | | | | exercises, 10-12 reps at 50% 1RM. | intensity exercise bouts (70-85% |
| | | | | Repetition speed: 4 second rep go to 6 second rep - Do | VO2 max) for a period of 15 to 30 |
| | | | | first half of set explosive then slow it down. | minutes, separated by 5 to 20 |
| | | | CC | Circuit Resistance training: 2-3 circuit sets, 6-10 | minutes rest. |
| | | | | exercises, 10-12 reps at 50% 1RM. | |
| | | | | Repetition speed: 2-4 sec rep - Explosive contraction/ | |
| | | | | normal speed retraction. | |
| | ID | ACTN3 | TT | Heavy Resistance training: 3-5 sets, 8-10 exercises, | Tempo training by means of |
| | | | | 4-10 reps at 70-80% 1RM for your power fibers, and | continuous aerobic exercise at a |
| | | | | Circuit Resistance training: 2-3 circuit sets, 6-10 | high-intensity (75-85% VO2 max) |
| | | | | exercises, 10-12 reps at 60% 1RM for your endurance | for a period of 30-60 minutes. |
| | | | | fibers. | |
| | | | | Repetition speed: 50% of sets 4 second rep and 50% of | |
| | | | | sets 6 second rep - Med. Speed, Pause between. | |
| | | | CT | Heavy Resistance training: 3-5 sets, 8-10 exercises, | Split training of 2 to 4 high- |
| | | | | 4-10 reps at 70-80% 1RM for your power fibers and | intensity exercise bouts (70-85% |
| | | | | Circuit Resistance training: 2-3 circuit sets, 6-10 | VO2 max) for a period of 10 to 20 |
| | | | | exercises, 10-12 reps at 60% 1RM for your endurance | minutes, separated by 5 pt 10 |
| | | | | fibers. | minutes of low intensity exercise |
| | | | | Repetition speed: 2 second rep go to 4 second rep - Do | bouts (30-40% VO2 max) |
| | | | | first half of set explosive then slow it down. | |
| | | | CC | Heavy Resistance training: 3-5 sets, 8-10 exercises, | |
| | | | | 4-10 reps at 70-80% 1RM for your power fibers and | |
| | | | | Circuit Resistance training: 2-3 circuit sets, 6-10 | |
| | | | | exercises, 10-12 reps at 60% 1RM for your endurance | |
| | | | | fibers will benefit you in your weight loss goals. | |
| | | | | Repetition speed: 50% of sets faster 1-2 sec rep and 50% | |
| | | | | of sets slower 3-4 sec rep - fast contraction/normal | |
| | | | | speed retraction. | |

TABLE 10
Heart rate intensity (bpm) for males

| | Low | Medium | | Supramaximal/ |
|---|---|---|---|---|
| | 30-50% | 60-75% | High 80-95% | EPOC 100-110% |
| Age | VO2 max | VO2 max | VO2 max | VO2 max |
| 21 | 112-137 | 150-169 | 176-195 | 201-214 |
| 22 | 111-137 | 149-168 | 175-194 | 200-213 |
| 23 | 111-136 | 149-167 | 174-193 | 199-212 |
| 24 | 110-135 | 148-167 | 173-192 | 198-211 |
| 25 | 110-135 | 147-166 | 172-191 | 197-209 |
| 26 | 109-134 | 146-165 | 171-190 | 196-208 |
| 27 | 108-133 | 146-164 | 170-189 | 195-207 |
| 28 | 108-132 | 145-163 | 169-188 | 194-206 |
| 29 | 107-132 | 144-162 | 168-187 | 193-205 |
| 30 | 107-131 | 143-162 | 168-186 | 192-204 |
| 31 | 106-130 | 143-161 | 167-185 | 191-203 |
| 32 | 106-130 | 142-160 | 166-184 | 190-202 |
| 33 | 105-129 | 141-159 | 165-183 | 189-201 |
| 34 | 105-128 | 140-158 | 164-182 | 188-200 |
| 35 | 104-128 | 139-157 | 163-181 | 187-199 |
| 36 | 103-127 | 139-156 | 162-180 | 186-198 |
| 37 | 103-126 | 138-156 | 161-179 | 185-197 |
| 38 | 102-126 | 137-155 | 161-178 | 184-195 |
| 39 | 102-125 | 136-154 | 160-177 | 183-194 |
| 40 | 101-124 | 136-153 | 159-176 | 182-193 |
| 41 | 101-124 | 135-152 | 158-175 | 181-192 |
| 42 | 100-123 | 134-151 | 157-174 | 180-191 |
| 43 | 99-122 | 133-150 | 156-173 | 179-190 |
| 44 | 99-121 | 133-150 | 155-172 | 178-189 |
| 45 | 98-121 | 132-149 | 154-171 | 177-188 |
| 46 | 98-120 | 131-148 | 153-170 | 176-187 |
| 47 | 97-119 | 130-147 | 153-169 | 175-186 |
| 48 | 97-119 | 130-146 | 152-168 | 174-185 |
| 49 | 96-118 | 129-145 | 151-167 | 173-184 |
| 50 | 96-117 | 128-145 | 150-166 | 172-183 |
| 51 | 95-117 | 127-144 | 149-165 | 171-182 |
| 52 | 94-116 | 127-143 | 148-164 | 170-180 |
| 53 | 94-115 | 126-142 | 147-163 | 169-179 |
| 54 | 93-115 | 125-141 | 146-162 | 168-178 |
| 55 | 93-114 | 124-140 | 146-161 | 167-177 |
| 56 | 92-113 | 124-139 | 145-160 | 166-176 |
| 57 | 92-112 | 123-139 | 144-159 | 165-175 |
| 58 | 91-112 | 122-138 | 143-158 | 164-174 |
| 59 | 90-111 | 121-137 | 142-157 | 163-173 |
| 60 | 90-110 | 121-136 | 141-156 | 162-172 |
| 61 | 89-110 | 120-135 | 140-156 | 161-171 |
| 62 | 89-109 | 119-134 | 139-155 | 160-170 |
| 63 | 88-108 | 118-133 | 138-154 | 159-169 |
| 64 | 88-108 | 118-133 | 138-153 | 158-168 |
| 65 | 87-107 | 117-132 | 137-152 | 157-166 |
| 66 | 87-106 | 116-131 | 136-151 | 156-165 |
| 67 | 86-106 | 115-130 | 135-150 | 155-164 |
| 68 | 85-105 | 115-129 | 134-149 | 154-163 |
| 69 | 85-104 | 114-128 | 133-148 | 153-162 |
| 70 | 84-104 | 113-128 | 132-147 | 152-161 |

TABLE 11
Heart rate intensity (bpm) for females

| | Low | Medium | | Supramaximal/ |
|---|---|---|---|---|
| | 30-50% | 60-75% | High 80-95% | EPOC 100-110% |
| Age | VO2 max | VO2 max | VO2 max | VO2 max |
| 21 | 105-129 | 141-159 | 165-183 | 189-201 |
| 22 | 105-129 | 141-159 | 165-183 | 189-200 |
| 23 | 104-128 | 140-158 | 164-182 | 188-200 |
| 24 | 104-128 | 139-157 | 163-181 | 187-199 |
| 25 | 103-127 | 139-156 | 162-180 | 186-198 |
| 26 | 103-126 | 138-156 | 162-179 | 185-197 |
| 27 | 102-126 | 137-155 | 161-178 | 184-196 |
| 28 | 102-125 | 137-154 | 160-177 | 183-195 |
| 29 | 101-125 | 136-153 | 159-177 | 182-194 |
| 30 | 101-124 | 135-153 | 158-176 | 181-193 |
| 31 | 100-123 | 135-152 | 158-175 | 181-192 |
| 32 | 100-123 | 134-151 | 157-174 | 180-191 |
| 33 | 99-122 | 133-150 | 156-173 | 179-190 |
| 34 | 99-121 | 133-150 | 155-172 | 178-189 |
| 35 | 98-121 | 132-149 | 155-171 | 177-188 |
| 36 | 98-120 | 131-148 | 154-170 | 176-187 |
| 37 | 97-120 | 131-147 | 153-170 | 175-186 |
| 38 | 97-119 | 130-147 | 152-169 | 174-185 |
| 39 | 96-118 | 129-146 | 151-168 | 173-184 |
| 40 | 96-118 | 129-145 | 151-167 | 173-183 |
| 41 | 95-117 | 128-144 | 150-166 | 172-182 |
| 42 | 95-117 | 127-144 | 149-165 | 171-182 |
| 43 | 95-116 | 127-143 | 148-164 | 170-181 |
| 44 | 94-115 | 126-142 | 148-164 | 169-180 |
| 45 | 94-115 | 125-141 | 147-163 | 168-179 |
| 46 | 93-114 | 125-141 | 146-162 | 167-178 |
| 47 | 93-114 | 124-140 | 145-161 | 166-177 |
| 48 | 92-113 | 123-139 | 144-160 | 165-176 |
| 49 | 92-112 | 123-138 | 144-159 | 165-175 |
| 50 | 91-112 | 122-138 | 143-158 | 164-174 |
| 51 | 91-111 | 121-137 | 142-158 | 163-173 |
| 52 | 90-111 | 121-136 | 141-157 | 162-172 |
| 53 | 90-110 | 120-135 | 141-156 | 161-171 |
| 54 | 89-109 | 119-135 | 140-155 | 160-170 |
| 55 | 89-109 | 119-134 | 139-154 | 159-169 |
| 56 | 88-108 | 118-133 | 138-153 | 158-168 |
| 57 | 88-108 | 118-132 | 137-152 | 157-167 |
| 58 | 87-107 | 117-132 | 137-152 | 157-166 |
| 59 | 87-106 | 116-131 | 136-151 | 156-165 |
| 60 | 86-106 | 116-130 | 135-150 | 155-165 |
| 61 | 86-105 | 115-129 | 134-149 | 154-164 |
| 62 | 85-104 | 114-129 | 134-148 | 153-163 |
| 63 | 85-104 | 114-128 | 133-147 | 152-162 |
| 64 | 84-103 | 113-127 | 132-146 | 151-161 |
| 65 | 84-103 | 112-126 | 131-146 | 150-160 |
| 66 | 83-102 | 112-126 | 130-145 | 149-159 |
| 67 | 83-101 | 111-125 | 130-144 | 149-158 |
| 68 | 82-101 | 110-124 | 129-143 | 148-157 |
| 69 | 82-100 | 110-123 | 128-142 | 147-156 |
| 70 | 81-100 | 109-123 | 127-141 | 146-155 |

The fitness plan schedule may also be combined with physiological tests, physical measurements and/or psychological assessments to more optimally design a training regimen for the subject. The subject may be assigned a certified personal trainer or other fitness professional to assist with the fitness program. The weight management software program may be accessible to the subject through a website to allow the subject to input changes in order to make adjustments to his/her diet and/or exercise. In one embodiment, the input comprises changes in one or more of the caloric intake, physical parameters, or energy expenditure events. Based on such input, the weight management software program modifies the meal and fitness plan schedules. For example, the weight management software system may generate a revised meal plan schedule based on an updated weight of the subject, or increase the intensity of a workout program following an improvement in the fitness level of the subject.

As will be apparent to those skilled in the art, various modifications, adaptations and variations of the foregoing specific disclosure can be made without departing from the scope of the invention claimed herein.

### REFERENCES

The following references are incorporated herein by reference (where permitted) as if reproduced in their entirety. All references are indicative of the level of skill of those skilled in the art to which this invention pertains.
Baier, L. J.; Sacchettini, J. C.; Knowler, W. C.; Eads, J.; Paolisso, G; Tataranni, P. A.; Mochizuki, H.; Bennett, P. H.; Bogardus, C. and Prochazka, M. An amino acid substitution in the human intestinal fatty acid binding protein is associated with increased fatty acid binding, increased fat oxidation, and insulin resistance. J Clin Invest. 1995 March; 95(3): 1281-1287.
Bender, L. H.; Draper, C.; Breton, G and Wilkins, L. Genetic marker weight management. United States Patent Application Publication No. US 2010/0098809, published Apr. 22, 2010.
Castellon, V.; Clinkscales, P.; Davis, J.; Debusk, R.; Gill, R.; Ng, S. S. and Swango, B. Weight management genetic test systems and methods. United States Patent Application Publication No. US 2012/0295256, published Nov. 22, 2012.
Draper, C.; Wilkins, L.; Breton, G.; Perusse, L.; Debusk, R.; Ramakrishnan, S. and Krempin, D. W. Genetic markers for weight management and methods of use thereof. Canadian Patent Application No. 2,724,497, published Nov. 19, 2009.
Hughes, T. P. Individualized genetically-determined dietary supplementation and exercise recommendation with container and dispenser for same. United States Patent Application Publication No. US 2013/0022951, published Jan. 24, 2013.
Kraft, D. L. System and methods for the production of personalized drug products. United States Patent Application Publication No. US 2012/0041778, published Feb. 16, 2012.
Moore, S. M.; Nierenberg, M. A.; George, S. E. and Gomer, L. A. Methods and systems for personalized action plans. United States Patent Application Publication No. US 2010/0042438, published Feb. 18, 2010.
Ordovas, J. M. and Corella, D. Method for personalized diet design. United States Patent Application Publication No. US 2009/0222282, published Sep. 3, 2009.
Ruano, G. and Windemuth, A. Physiogenomic method for predicting clinical outcomes of treatments in patients. U.S. Pat. No. 7,747,392, issued Jun. 29, 2010.
Ruano, G.; Windemuth, A. and Thompson, P. D. Physiogenomic method for predicting effects of exercise. United States Patent Application Publication No. US 2008/0070247, published Mar. 20, 2008.
Slater, B.; Colby, B.; Colby, M. and Colby, B. Genetic analysis. Canadian Patent Application No. 2,718,887, published Sep. 24, 2009.

What is claimed is:

1. A method of individualized weight management for a subject comprising the steps of:
(a) obtaining a biological sample from the subject;
(b) detecting the presence or absence of polymorphisms associated with at least seven genes comprising fatty acid-binding protein 2 (FABP2), peroxisome proliferator-activated receptor gamma (PPARG), beta-2-adrenergic receptor (ADRB2), beta-3-adrenergic receptor (ADRB3), angiotensin-converting enzyme (ACE), alpha-actinin-3 (ACTN3), and proton-linked monocarboxylate transporter (MCT1) in the biological sample to obtain genotype pattern data for the subject; wherein the polymorphisms are indicative of at least one nutritional trait and at least one fitness trait; and
(c) preparing a nutritional and fitness program based on the subject's genotype pattern data;
wherein the fitness program comprises sequences of resistance, cardio, and excess post-exercise oxygen consumption (EPOC) training routines.

2. The method of claim 1, wherein the biological sample is selected from a cell, tissue, blood, or saliva.

3. The method of claim 2, wherein the biological sample is DNA.

4. The method of claim 3, wherein the step of detecting the presence or absence of the polymorphisms comprises direct DNA sequencing.

5. The method of claim 1, wherein the polymorphisms comprise FABP2 (AA, GA, or GG), PPARG (CC, GC, or GG), ADRB2 codon 16 (GG, GA, or AA), ADRB2 codon 27 (GG, GC, or CC), ADRB3 (CC, TT, or CT), ACE (DD, II, or ID), ACTN3 (TT, CT, or CC), and MCT1 (AA, AT, or TT).

6. The method of claim 1, wherein the at least one nutritional trait is selected from carbohydrate metabolism, fat metabolism, fat absorption, and fat release by fat cells.

7. The method of claim 1, wherein the at least one fitness trait is selected from endurance, power, sprint performance, lactate removal, and mobilization of fat stores.

8. The method of claim 1, further comprising performing an initial assessment of the subject to gather initial data on the subject's physical parameters and weight loss goals, and inputting the initial data into a computer storing a software program.

9. The method of claim 8, wherein the physical parameters comprise one or more of age, gender, ethnicity, weight, height, body fat percentage, body fat mass, lean body mass, body mass index, measurements of body parts when relaxed and flexed, cardiovascular condition, muscular strength and condition, and presence or absence of disease.

10. The method of claim 8, further comprising correlating the subject's polymorphisms for the FABP2, PPARG, ADRB2, and ADRB3 genes, and sensitivities to fat and carbohydrate, to a diet comprising a macronutrient ratio and fiber intake.

11. The method of claim 10, comprising assigning a low fat, low carbohydrate, and high protein diet providing about 20% to about 25% fat, about 25% to about 35% carbohydrate, and about 40% to about 55% protein all on a percent calories basis, and about 30 g to about 35 g of fiber daily, to a subject sensitive to fat and sensitive to carbohydrate, and exhibiting a combined genotype of:
i) FABP2 (AA), PPARG (CC), ADRB2 codon 16 (GG), ADRB2 codon 27 (GG), and ADRB3 (TT, CC or CT);
ii) FABP2 (AA), PPARG (CC), ADRB2 codon 16 (GG), ADRB2 codon 27 (GC), and ADRB3 (TT, CC or CT);
iii) FABP2 (GA), PPARG (CC), ADRB2 codon 16 (GG or GA), ADRB2 codon 27 (GG), and ADRB3 (TT, CC or CT);
iv) FABP2 (GA), PPARG (CC), ADRB2 codon 16 (GG or GA), ADRB2 codon 27 (GC), and ADRB3 (TT, CC or CT);
v) FABP2 (GG), PPARG (CC), ADRB2 codon 16 (GA or AA), ADRB2 codon 27 (GG), and ADRB3 (CC or CT); or
vi) FABP2 (GG), PPARG (CC or GC), ADRB2 codon 16 (GG or GA or AA), ADRB2 codon 27 (GC), and ADRB3 (CC or CT).

12. The method of claim 10, comprising assigning a low fat, high carbohydrate, and moderate protein diet providing about 20% to about 25% fat, about 45% carbohydrate, and about 30% to about 35% protein all on a percent calories basis, and about 25 g to about 30 g of fiber daily, to a subject sensitive to fat and moderately sensitive to carbohydrate, and exhibiting a combined genotype of:
i) FABP2 (AA), PPARG (CC or GC), ADRB2 codon 16 (GG), ADRB2 codon 27 (CC), and ADRB3 (TT, CC or CT);
ii) FABP2 (GA), PPARG (CC or GC), ADRB2 codon 16 (GG or GA), ADRB2 codon 27 (CC), and ADRB3 (TT, CC or CT); or
iii) FABP2 (GG), PPARG (CC or GC), ADRB2 codon 16 (GG or GA or AA), ADRB2 codon 27 (CC), and ADRB3 (CC or CT).

13. The method of claim 10, comprising assigning a high fat, low carbohydrate, and moderate protein diet providing about 30% to about 35% fat, about 25% to about 35% carbohydrate, and about 30% to about 45% protein all on a percent calories basis, and about 25 g to about 35 g of fiber daily, to a subject tolerant to fat and sensitive to carbohydrate, and exhibiting a combined genotype of:
i) FABP2 (GG), PPARG (CC), ADRB2 codon 16 (GA or AA), ADRB2 codon 27 (GG), and ADRB3 (TT);
ii) FABP2 (GG), PPARG (CC or GC), ADRB2 codon 16 (GG or GA or AA), ADRB2 codon 27 (GC), and ADRB3 (TT);
iii) FABP2 (GG), PPARG (GG or GC), ADRB2 codon 16 (GA or AA), ADRB2 codon 27 (GG), and ADRB3 (TT, CC or CT); or
iv) FABP2 (GG), PPARG (GC), ADRB2 codon 16 (GA or AA), ADRB2 codon 27 (GC), and ADRB3 (TT, CC or CT).

14. The method of claim 10, comprising assigning a high fat, high carbohydrate, and low protein diet providing about 30% to about 35% fat, about 45% carbohydrate, and about 20% to about 25% protein all on a percent calories basis, and about 25 g of fiber daily, to a subject tolerant to fat and moderately sensitive to carbohydrate, and exhibiting a combined genotype of:
i) FABP2 (GG), PPARG (CC or GC), ADRB2 codon 16 (GG or GA or AA), ADRB2 codon 27 (CC), and ADRB3 (TT); or
ii) FABP2 (GG), PPARG (GG), ADRB2 codon 16 (GA or AA), ADRB2 codon 27 (CC), and ADRB3 (TT, CC or CT).

15. The method of claim 10, wherein the subject exhibits a combined genotype of:
i) FABP2 (AA), PPARG (CC), ADRB2 codon 16 (GG), ADRB2 codon 27 (GG), and ADRB3 (TT, CC or CT); or
ii) FABP2 (GA), PPARG (CC), ADRB2 codon 16 (GG or GA), ADRB2 codon 27 (GG), and ADRB3 (CC or CT); and
wherein the macronutrient ratio and fiber intake comprises 20% fat, 25% carbohydrate, 55% protein all on a percent of calories basis, and 35 g fiber daily.

16. The method of claim 10, wherein the subject exhibits a combined genotype of:
i) FABP2 (AA), PPARG (CC), ADRB2 codon 16 (GG), ADRB2 codon 27 (GG), and ADRB3 (TT, CC, or CT); or
ii) FABP2 (GA), PPARG (CC), ADRB2 codon 16 (GG or GA), ADRB2 codon 27 (GC), and ADRB3 (CC or CT); and
wherein the macronutrient ratio and fiber intake comprises 20% fat, 35% carbohydrate, 45% protein all on a percent of calories basis, and 35 g fiber daily.

17. The method of claim 10, wherein the subject exhibits a combined genotype of:
i) FABP2 (AA), PPARG (CC or GC), ADRB2 codon 16 (GG), ADRB2 codon 27 (CC), and ADRB3 (TT, CC, or CT); or
ii) FABP2 (GA), PPARG (CC or GC), ADRB2 codon 16 (GG or GA), ADRB2 codon 27 (CC), and ADRB3 (CC or CT); and
wherein the macronutrient ratio and fiber intake comprises 20% fat, 45% carbohydrate, 35% protein all on a percent of calories basis, and 30 g fiber daily.

18. The method of claim 10, wherein the subject exhibits a combined genotype of:
i) FABP2 (GA), PPARG (CC), ADRB2 codon 16 (GG or GA), ADRB2 codon 27 (GG), and ADRB3 (TT); or
ii) FABP2 (GG), PPARG (CC), ADRB2 codon 16 (GA or AA), ADRB2 codon 27 (GG), and ADRB3 (CC or CT); and
wherein the macronutrient ratio and fiber intake comprises 25% fat, 25% carbohydrate, 50% protein all on a percent of calories basis, and 35 g fiber daily.

19. The method of claim 10, wherein the subject exhibits a combined genotype of:
i) FABP2 (GA), PPARG (CC), ADRB2 codon 16 (GG or GA), ADRB2 codon 27 (GG), and ADRB3 (TT); or
ii) FABP2 (GG), PPARG (CC or GC), ADRB2 codon 16 (GG, GA or AA), ADRB2 codon 27 (GC), and ADRB3 (CC or CT); and
wherein the macronutrient ratio and fiber intake comprises 25% fat, 35% carbohydrate, 40% protein all on a percent of calories basis, and 30 g fiber daily.

20. The method of claim 10, wherein the subject exhibits a combined genotype of:
i) FABP2 (GA), PPARG (CC or GC), ADRB2 codon 16 (GG or GA), ADRB2 codon 27 (CC), and ADRB3 (TT); or
ii) FABP2 (GG), PPARG (CC or GC), ADRB2 codon 16 (GG, GA or AA), ADRB2 codon 27 (CC), and ADRB3 (CC or CT); and
wherein the macronutrient ratio and fiber intake comprises 25% fat, 45% carbohydrate, 30% protein all on a percent of calories basis, and 25 g fiber daily.

21. The method of claim 10, wherein the subject exhibits a combined genotype of:
i) FABP2 (GG), PPARG (CC), ADRB2 codon 16 (GA or AA), ADRB2 codon 27 (GG), and ADRB3 (TT); or
ii) FABP2 (GG), PPARG (GG or GC), ADRB2 codon 16 (GA or AA), ADRB2 codon 27 (GG), and ADRB3 (CC or CT); and
wherein the macronutrient ratio and fiber intake comprises 30% fat, 25% carbohydrate, 45% protein all on a percent of calories basis, and 35 g fiber daily.

22. The method of claim 10, wherein the subject exhibits a combined genotype of:
i) FABP2 (GG), PPARG (CC or GC), ADRB2 codon 16 (GG, GA or AA), ADRB2 codon 27 (GC), and ADRB3 (TT); or
ii) FABP2 (GG), PPARG (GC), ADRB2 codon 16 (GA or AA), ADRB2 codon 27 (GC), and ADRB3 (CC or CT); and
wherein the macronutrient ratio and fiber intake comprises 30% fat, 35% carbohydrate, 35% protein all on a percent of calories basis, and 30 g fiber daily.

23. The method of claim 10, wherein the subject exhibits a combined genotype of:
i) FABP2 (GG), PPARG (CC or GC), ADRB2 codon 16 (GG, GA or AA), ADRB2 codon 27 (CC), and ADRB3 (TT); or
ii) FABP2 (GG), PPARG (GG), ADRB2 codon 16 (GA or AA), ADRB2 codon 27 (CC), and ADRB3 (CC or CT); and
wherein the macronutrient ratio and fiber intake comprises 30% fat, 45% carbohydrate, 25% protein all on a percent of calories basis, and 25 g fiber daily.

24. The method of claim 10, wherein the subject exhibits a combined genotype of FABP2 (GG), PPARG (GG or GC), ADRB2 codon 16 (GA or AA), ADRB2 codon 27 (GG), and ADRB3 (TT); and wherein the macronutrient ratio and fiber intake comprises 35% fat, 25% carbohydrate, 40% protein all on a percent of calories basis, and 30 g fiber daily.

25. The method of claim 10, wherein the subject exhibits a combined genotype of FABP2 (GG), PPARG (GC), ADRB2 codon 16 (GA or AA), ADRB2 codon 27 (GC), and ADRB3 (TT); and wherein the macronutrient ratio and fiber intake comprises 35% fat, 35% carbohydrate, 30% protein all on a percent of calories basis, and 25 g fiber daily.

26. The method of claim 10, wherein the subject exhibits a combined genotype of FABP2 (GG), PPARG (GG), ADRB2 codon 16 (GA or AA), ADRB2 codon 27 (CC), and ADRB3 (TT); and wherein the macronutrient ratio and fiber intake comprises 35% fat, 45% carbohydrate, 20% protein all on a percent of calories basis, and 25 g fiber daily.

27. The method of claim 10, further comprising the step of determining the subject's caloric intake goal based on the subject's macronutrient ratio, physical parameters, weight loss goals, and energy expenditure events.

28. The method of claim 27, further comprising the step of generating meal and fitness plan schedules.

29. The method of claim 28, wherein the meal plan schedule comprises weekly grocery lists, details for meal selection and preparation, and food exchange tables.

30. The method of claim 28, wherein the fitness plan schedule is prescribed based on the subject's polymorphisms for the ACE, ACTN3, MCT1, ADRB2, and ADRB3 genes.

31. The method of claim 30, wherein the fitness plan schedule comprises a workout program prescribing sequences of resistance exercises based on the subject's polymorphisms for the ACE (DD, II, or ID), ACTN3 (TT, CT, or CC) and MCT1 (AA, AT, or TT) genes; sequences of cardio exercises based on the subject's polymorphisms for the ACE (DD, II, or ID), ADBR2 codon 27 (GG, GC, or CC) and ADBR3 (CC, TT, or CT) genes; and sequences of EPOC exercises based on the subject's polymorphisms for the ACE (DD, II, or ID) and ACTN3 (TT, CT, or CC) genes.

32. The method of claim 30, further comprising gathering data on the subject's physical parameters at multiple time intervals, and calculating the changes in the physical parameters between each time interval.

33. The method of claim 32, further comprising the step of modifying the meal and fitness plan schedules based on input received from the subject.

34. The method of claim 33, wherein the input comprises changes in one or more of the caloric intake, physical parameters, or energy expenditure events.

35. The method of claim 34, further comprising performing a final assessment to gather final data on the subject's physical parameters, and inputting the final data into the software program to calculate the changes in the subject's physical parameters, and to compare the physical parameters at the initial and final assessments.
